(19) United States
(12) Patent Application Publication
(10) Pub. No.: US 2020/0226511 A1
(43) Pub. Date: Jul. 16, 2020

(54) WATER RISK MANAGEMENT SYSTEM

(71) Applicant: Aquaoso Technologies, PBC, Folsom, CA (US)

(72) Inventors: Cameron Burford, Folsom, CA (US); Blake Atkerson, Folsom, CA (US); Jeffrey Parrish, Folsom, CA (US); Christopher Peacock, Folsom, CA (US)

(21) Appl. No.: 16/744,683

(22) Filed: Jan. 16, 2020

Related U.S. Application Data
(60) Provisional application No. 62/793,067, filed on Jan. 16, 2019.

(51) Int. Cl. G06Q 10/06; G06Q 50/26; G06Q 30/02; G06N 3/04; G06Q 40/02; G06Q 50/02; G06N 3/08; G06F 3/0484; G06F 3/0482

(52) U.S. Cl. CPC G06Q 10/0635; G06Q 50/26; G06Q 30/0206; G06N 3/0454; G06Q 40/025; G06F 3/0482; G06N 3/0427; G06Q 10/06313; G06N 3/08; G06Q 30/0205; G06F 3/04847; G06Q 50/02

(57) ABSTRACT

A system utilizes a plurality of neural networks to assess a score indicating relative risk of whether water supply for a selected parcel of land or other geographic area will be sufficient for water management according to regulatory requirements and/or future intended uses of the land.

### RELATED APPLICATIONS

This application claims benefit of priority to U.S. provisional patent application No. 62/793,067 filed Jan. 16, 2019, which is hereby incorporated by reference to the same extent as though fully replicated herein.

### BACKGROUND

### Field of the Invention

The present disclosure pertains to the field of water management and, more particularly, electronic systems for managing actual water usage according in context of regulatory oversight of water usage. Specifically, the disclosure pertains to risk allocation and management of water supplies.

### DESCRIPTION OF THE RELATED ART

Originating at about the time of the California gold rush, prior apportionment of water rights is the dominant system now in use for water rights management in the American West. Under prior apportionment theory, the first person to take a quantity of water from a water source for beneficial use has the right to continue to use that quantity of water for that purpose. Beneficial uses are typically agricultural, industrial or household. This is a system of regulatory allocation where subsequent or ‘junior’ users may take the remaining water for their own beneficial use if they do not impinge on the rights of earlier or ‘senior’ users.

Prior apportionment differs from riparian water rights, which are applied in the Eastern United States. In riparian systems, all landowners whose properties adjoin a body of water have the right to make reasonable use of the water as it flows through or over their properties. If there is not enough water to satisfy all users, allotments are generally fixed in proportion to frontage on the water source. These rights cannot be sold or transferred other than with the adjoining land and, even then, only in reasonable quantities associated with the adjoining land. The water cannot be transferred out of the watershed without due consideration as to the rights of the downstream riparian landowners. Some Western States, such as California, may recognize a mixture of prior apportioned and riparian rights.

Management of water rights in the United States is in disarray. Large uncertainties exist due to differences in water sources, such as ground water versus surface water where production of groundwater may cause surface water to drain into the ground. Agencies that manage water rights may be underfunded. Production or taking data is often underreported or unavailable for a number of reasons. This sometimes makes it very difficult to assess, for example, whether a parcel of land that is being sold will have sufficient water for the intended purposes of the transaction. The answers to questions of water risk management are frequently in the domain of experts who must consider such factors as how much water will be required to grow a particular crop, the sources of that water, and where the intended use falls on the scale of prior apportionment. It is often impossible to complete a meaningful analysis because of the lack of data and a failure to comprehend the complexity of water delivery systems that may interact with one another.

### SUMMARY

The presently disclosed instrumentalities advance the art and overcome the problems outlined above by providing a naturally intelligent algorithm that may be utilized to assess relative risk defined as whether a parcel of land will have sufficient water over time to meet future intended uses.

By way of example, a bank may be considering a loan to acquire a farm or orchard that grows water-intensive produce, such as almonds. If available water is predicted to at substantial risk of running short of the amount that is required for agricultural operations, then there needs to be a backup plan for a workable crop that may be grown to assure that the loan is paid.

According to one embodiment, a water risk analysis system is specially programmed into a computer having at least one processor, access to data storage, and electronic memory. A risk mitigation module is stored in the memory to provide program instructions that are executable by the processor for running an artificially intelligent algorithm that has been trained as a model for water risk analysis that assesses a score indicating relative risk characterizing whether a geographic area of land has access to a sufficient water supply for an intended use under a system of supply regulation. The artificially intelligent algorithm results from a training data set including variables affecting, for example, water supply, water supply reliability, cost of water, and water quality associated with a geographic area. In like manner, inputs to the artificially intelligent algorithm when used as a predictive model of relative risk include values for variables affecting water supply, water supply reliability, cost of water, water quality, and identification of the geographic area. The model provides the score based upon these input values, and the score is presented to a user, for example, through use of a graphical user interface (GUI).

In one aspect, the water risk analysis system may include a synthetic data set of estimated values for one or more of the variables where actual values are unavailable in raw data used to train the model. The synthetic data set is used to train the artificially intelligent algorithm in producing or improving the model.

In one aspect, the artificially intelligent algorithm may be a first neural network. Additional neural networks may be utilized for creating the synthetic data set.

In one aspect, the program instructions may include those for submitting the score to downstream processing. Examples of downstream processing instructions include those for:
Applying the score as an aid to a lender who must consider the risk that a shortage of water may cause an agricultural loan to fail or that such a loan might need to be refinanced;
Assisting governmental planning in assessing a need to lock up sources of water supply that will be consumed by contemplated population growth;
Aiding farm crop planning; or
Aiding regulatory planning to meet minimum required stream flows.

In one aspect, the system of supply regulation may be a prior appropriation system. Alternatively, the system of supply regulation may be a riparian system.

In various aspects, the model of the water risk analysis system may encompass multiple water sources selected from the group in any combination consisting of ditch water, river water, ground water, and well water.

In one aspect, the instructions for presenting the score may include associating the score with a color and the geographic area. The mode of presentation may be time sequential animation for presentation of score values that change over time.

In one aspect, the program instructions may provide for reporting such that a user may delimit data for use as input to the model. The data may be, for example, taken form data that is used to train of validate the model.

In one aspect, the program instructions may be provided in storage on a non-transitory computer-readable storage medium.

### BRIEF DESCRIPTION OF THE DRAWINGS

FIG. 1 shows a water risk analysis system according to one embodiment;

FIG. 2 is a flowchart of program logic for operation of the water risk analysis system;

FIG. 3 provides additional information concerning neural network modeling for application in the water risk analysis system;

FIG. 4 shows program login for user interaction in a reporting function that accesses a data set to delimit data for use as input to the model of the water risk analysis system;

FIG. 5 shows a GUI with output produced by the water risk analysis system;

FIG. 6 shows a GUI with output produced by the water risk analysis system; and

FIG. 7 shows a logical process of applying risk analysis to inform a transaction

FIG. 8 shows a logical process of using the water risk analysis system as an aid to lender in evaluating the terms of an agricultural loan on the basis that a shortage of water may cause the loan to fail;

FIG. 9 shows a logical process of using the water risk analysis system as an aid to water management planning by a municipality or a State in acquiring sources of water supply that will be consumed by contemplated population growth;

FIG. 10 shows a logical process of using the water risk analysis system as an aid to a farmer who is determining what crop to grow;

FIG. 11 shows a logical process of using the water risk analysis system as an aid to a regulatory agency that is planning to provide minimum required stream flows;

FIG. 12 shows a logical process of using the water risk analysis system as an aid to conduct prior apportionment analysis using a synthetic data set;

FIG. 13 shows a logical process of using the water risk analysis system as an aid to evaluating an insurance policy that considers risk that of a shortage of water may cause the insurance policy to distribute insurance proceeds; and

FIG. 14 shows a logical process of using the water risk analysis system as an aid to evaluating an insurance policy that considers risk that of a shortage of water may cause the insurance policy to distribute insurance proceeds.

### DETAILED DESCRIPTION

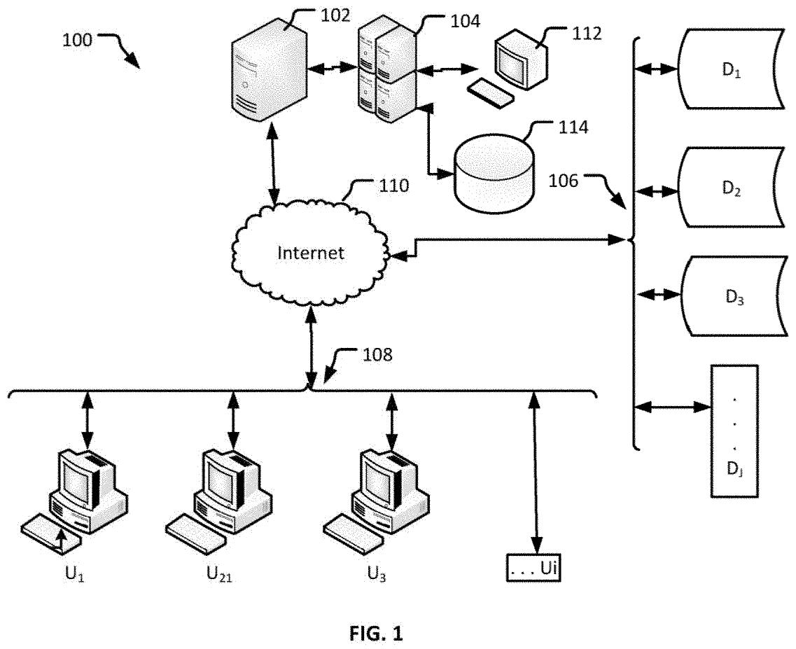

FIG. 1 shows a system 100 that is constructed according to one embodiment of what is disclosed. The system 100 includes a central server 102 a configured as a gateway connecting an application server 104 with a group of data suppliers 106 including suppliers D₁, D₂, D₃ . . . D_{J}, and a group of users 108 including users U₁, U₂, U₃, Uᵢ. through use of the Internet 110. The application server 104 is specially programmed with program instructions for practicing risk management of water rights according to one or more processes outlined below. The users 108 include, for example, anyone who is a stakeholder interested in water rights, such as banks or other businesses involved in the sale of land or water rights, farm managers, and ditch water companies or other water cooperatives. In other aspects, the users 108 may include regulatory agencies such as governmental or quasi-governmental organizations that oversee water usage from a local, state, regional or international perspective. There may be any number of users 108.

The data suppliers 106 include public and private sources of external raw data. Program logic controlling the operation of computer 112 permits the system 100 to access these various raw data sources, delimit or smooth the raw data for modeling use, and supply estimates of missing raw data to provide a combined processed data set that resides in one or more databases 114. It will be appreciated that the elements of FIG. 1, while shown singly in FIG. 1, may be provided in a distributed processing and/or distributed databasing environment.

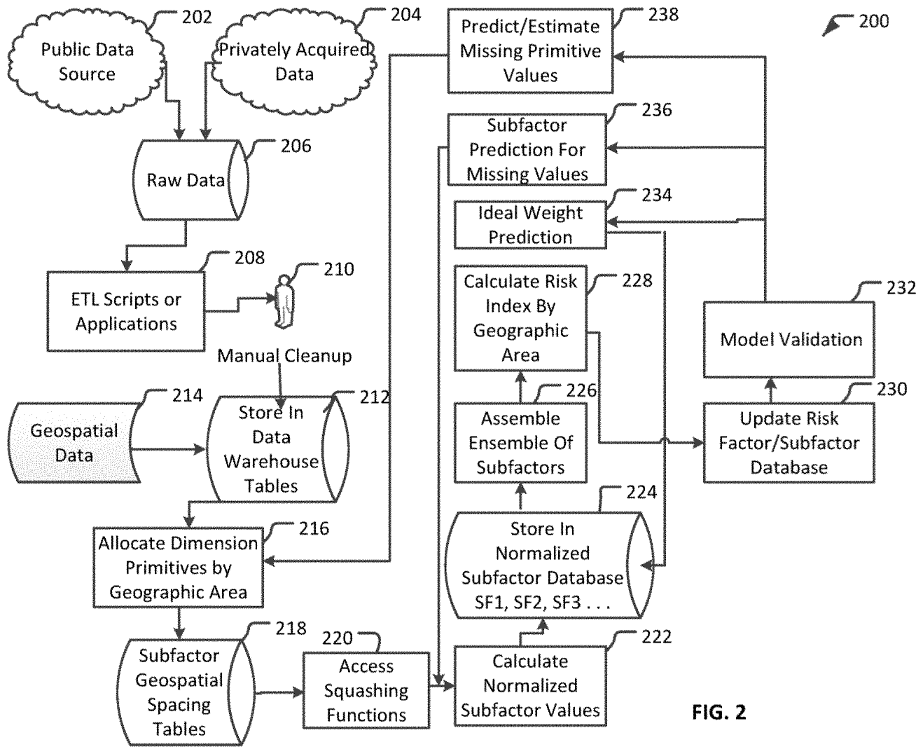

FIG. 2 is a diagram of program logic 200 that may be used on the computer 112 of FIG. 1, according to one embodiment, to create and validate a model that ultimately runs on the application server 104. The application server 104 may host many such models, each of which are trained with specificity to a particular region, water source, or regulatory organization. In context of FIG. 1, the data suppliers 106 of FIG. 2 include public data sources 202 and privately acquired data 204. The public data sources may include, for example, data that is published by the various regional Water Boards of a State, which in California would include Region 1 (North Coast), Region 2 (San Francisco Bay), Region 3 (Central Coast), etc. . . . The privately acquired data 204 might include, for example, a combined data set that is compiled by a professional association of these water boards on a State or Regional level or a private contractor that is engaged for this purpose.

The program logic 112 downloads this data into a combined raw data set 206. The raw data set 206 will have many problems, such as extraneous or missing values for reported water usage. By way of example, the operator of a well or a user of ditch water may neglect to report values for allocation of this water when the water is used on a particular parcel of land. As used herein, a “parcel” is defined as land having discrete boundaries with unified ownership. In one example of this, half of a township/range section of land may be owned by Farmer A and the other half by Farmer A and his sister. These constitute two separate parcels.

Extract, Transform, Load (“ETL”) scripts or other similar applications 208 are provided to implement an expert system of preprocessing rules for resolving problems in the combined raw data set 206. The ETL scripts or other applications may be provided, for example, to:
Allocate Known Gross Quantities of Water. By way of example, an acreage of land may be allocated a percentage of a gross amount of ditch water that turns out to be ten acre-feet in a year of plenty and five acre-feet in a year of drought. The allocation may alternatively be ten acre feet of river water without variance, or ten acre-feet of groundwater but only when hay is grown on the land. These rules are parcel specific and associate quantities of water with use-specific water rights that are allocable under the applicable riparian or prior appropriation water rights management system in use for the parcel.
Estimate missing quantities of reported water usage. The usage data that gets reported to or which is published by a regulatory agency or other governing body can be very spotty. The data may contain missing values, such that uncertainty exists whether no water usage was reported because none was used, or there was simply a failure to report values actually used, or the values were reported but there was a failure by the receiving agency to publish the information. If, for example, a regulatory agency publishes annual usage information every five years, then a least squares or other correlation such as interpolation may be used to estimate or project water usage in for missing values. Alternatively, these estimates may be omitted here but provided in downstream processing steps.
Transform Data. Written or printed data may be transformed into digital data using optical character recognition. If there is a complete absence of volumetric water usage data, satellite images may be processed by spectrographic analysis that associates the intensity of predetermined bandwidths with an estimate of water usage that is associated, for example, by correlation with the kind and quality of a particular crop that is grown in the region. By way of example, corn may have a hue that identifies itself as corn, where variances in green or yellow hue at a particular time in the season may indicate the quality of the corn as a measure of irrigation water in use. In this instance, a multiple order, multivariate linear regression, such as a least squares fit, may indicate the water in use on a particular parcel.
Delimit Data. Data entry or reporting errors sometimes exist. For example, a value of 100,000 acre-feet of water may be reported when 10 acre feet was intended. This will usually be apparent by comparison to adjacent values in the data set such that clearly erroneous values may be deleted and replaced by such techniques as averaging by first forward differencing or backward differencing.
Smooth Data. In some instances where there are gaps in the data set or where the data set spikes in jagged edges, it may be appropriate to implement data averaging algorithms, such as a least squares correlations or averaging by first forward differences or backward differences.
Subclassify For Analogy to Similarly Situated Land. In a particular region, some parcels may be irrigated, and others not. Some may grow corn, others wheat or almonds. Rather than create a blanket estimator to provide the foregoing system functionalities, the parcels may be subclassified for similar treatment according to the foregoing instrumentalities.

The incoming preprocessed data is optionally but preferably submitted to human review 210 for manual cleanup before being stored 212 in data warehouse tables. At this time the data may be associated with externally provided geospatial data 214 such that the water usage and/or water rights allocation data may be associated with land at the parcel level or at another level of land subdivision into a geographic area. This type of land division may be, for example, a drainage basin for surface water such as a river or creek drainage, a surface of land covering a particular aquifer, a city, a state, a county, and/or a regulatory region for water management.

The data from the data warehouse is then allocated 216 into dimension (array) primitives by association with the geographic area. This may be any geographic area as discussed above, but will usually be done at the parcel level. By way of example, a dimension of water usage over time may be allocated to parcels on the basis of acreage. A dimension of rights to use water by prior apportionment may then also be allocated to each parcel based upon the acreage of the parcel. The geographically allocated data is stored in subfactor geospatial spacing tables 218. As used herein, the geographically allocated, dimensions are referred to as subfactors. More generally, a subfactor is a component or array of data that may be utilized in a combination of such subfactors which, together, form an ensemble of subfactors. The ensemble is also referred to herein as a “factor” when subfactors of the ensemble carry significant weight in a neural network model or other naturally intelligent algorithm for predicting values of the factor.

As an aid to modeling uniformity, it is an optional but preferable feature of the processing is to access 220 squashing or transformation functions for each subfactor. By way of example, a squashing function may transform the subfactor into to a relative indicator of value that may be dimensionless. It is possible to convert the array into values ranging from 0 to 1, for example, by dividing each element of the array by a maximum value in the array. A squashing function may also be any mathematical function, but is most often used to convert large values into a range of small values. Transformation functions may be linear or nonlinear, continuous or discontinuous. In other instances, the squashing function may represent the array as a range of associated values in a histogram of the array where the association is by decile, quartile or other subdivision of the histogram.

The squashing functions are used to calculate 222 normalized subfactor values, which are stored 224 in a normalized subfactor database. The respective subfactors are assembled 226 into a one or more ensembles. The factors are used to calculate 228 a risk index by a geographic area, such as a parcel. This calculation is optionally but preferably done by the use of an artificially intelligent algorithm, such as a neural network. The listing below provides a list of Factors that form the most relevant subfactors which are provided beneath each factor.

Factor A: Water Supply
A1 Water Budget per parcel (water supply minus water demand)
A2 Groundwater pumping restrictions for parcel
A3 Water Storage available to the water district where the parcel is location

Factor B: Water Reliability
B1 Historical Changes to surface water supply available to water district where parcel resides.
B2 Reliance of parcel on groundwater.
B3 Water storage capacity for water district where parcel is located.
B4 Frequency of drought conditions on parcel.
B5 Whether parcel is not served by a water district or mutual water company, also known as the “white area.”

Factor C: Cost of Water
C1 Cost of surface water per acre-foot accessible by the parcel.
C2 Energy cost to pump groundwater.
C3 Cost of parcel owner to import water.

Factor D: Water Quality
D1 Salinity level of the surface/groundwater.
D2 Nitrate level of the surface/groundwater.
D3 Groundwater Table Depth.

Factor X: Additional Risk Factors
X1 Subsidence on the parcel.
X2 Storie Index for parcel.
X3 Irrigated and Non-Irrigated Lands Class for parcel.
X4 Soil Agricultural Groundwater Banking Index for parcel.
X5 Strength of Water Rights by parcel.
X6 Precipitation on parcel.

Other useful data for the model may include:
Time-Series Water Delivered to the Water District Data, historical and present;
Time-Series Evapotranspiration and Applied Water Data by crop, county, groundwater basin, and water district.
Time-Series Precipitation and micro-climate data for water district, county, watershed, and groundwater basin.
Access to and amount of water storage capacity for both above ground and underground storage.
Water Transfer and Exchange Transactions
Time-Series Cost of water charged by the Water District or Privately-Owned

Water Company
Time-Series Cost of electricity to operate groundwater pumping operation by well owner
Time-Series Nitrate and Salinity levels for groundwater and surface water by groundwater basin and watershed.
Priority of water right held by owner of a parcel
Soil Productivity Index
Time-Series Crop Commodity prices for county, state, nation, global contexts.

Neural networks are commonly known and understood in the art. The software for creating and operating neural networks is presently available as Python-based open source code that is downloadable on the Internet. Specific examples of this code include, for example, Neural Designer, Keras, and Tflearn.

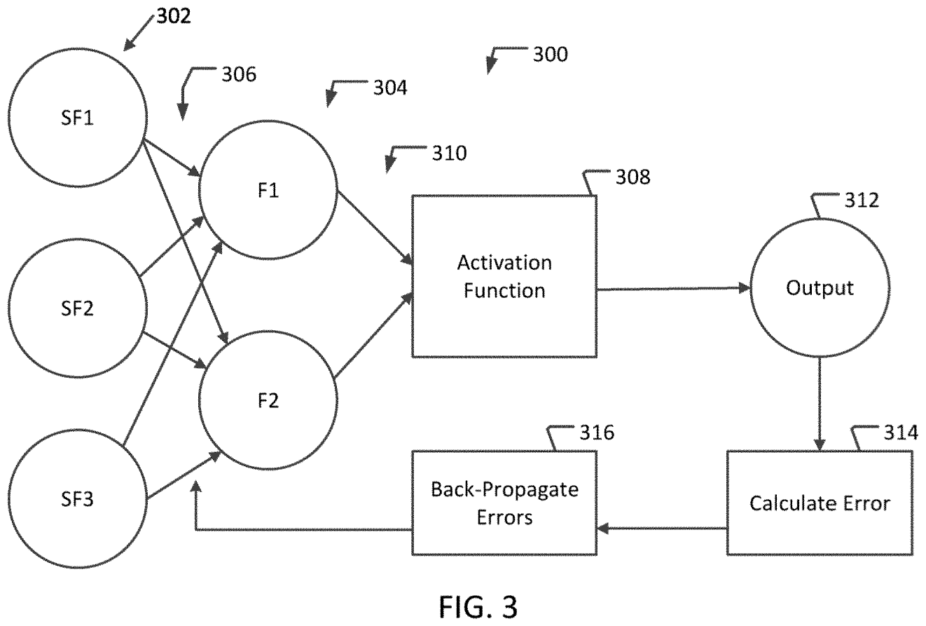

FIG. 3 shows a neural network structure 300 that may be used according to the presently described instrumentalities. Inputs include transformed or normalized subfactors 302 including SF1, SF2, SF3, etc. as described above. There may be any combination of subfactors, which are connected to Factors 304 including factors F1, F2 by weighted connectors 306. The factors 304 are associated to an activation function 308 by weighted connectors 310. The activation function 308 utilizes the assigned weights to calculate an output 312, which in this case is a risk index or risk score. The model is trained on an iterative basis where, for example, 60% of an available data set may be used to train the model and 40% may be used to validate the model. The model is trained by calculating error 314 in the test data set and back-propagating the error 316 for adjustment of the weighting factors to improve the model.

Step 226 may be repeated with different ensembles to enhance the predictive value of the model. The model may also be improved by substituting the squashing or transformation functions that are used to normalize the data set. The factors 304 may be referred to as hidden factors in a neural network model. Once training is complete, the steps 314, 316 may be eliminated to create a static model. A dynamic model is constantly learning and accepts new data with the progression of time with steps 314, 316 being used to provide periodic updates of the model.

Returning now to FIG. 2, step 228 calculates a risk index by geographic area, such as a parcel or drainage basin. The step 228 may use a neural network to produce this score as the output 312 of FIG. 3. The values of factors and subfactors that contributed to this score may be updated and stored 230 to assure that the output is repeatable. The output is then validated 232 by calculation of error (see FIG. 3, step 314). Model validation 232 occurs with back-propagation of error to revise the respective weighting factors 306, 310 (see FIG.; 3). This is an iterative process that results in recognition of the ideal weighting factors 234 for the model.

Desired values from the raw data 206 may be missing in some instances. While these may be provided or estimated by the use of ETL scripts 208 or other software applications, these values are preferably but optionally improved as part of the model validation process. Each of the Factors shown above my be calculated according to its own neural network. By way of example Factor A may be calculated using a neural network that is trained by use of subfactors, A1, A2, A3. This neural network calculation may be used in place of the initial estimates, which are optionally avoided altogether. Accordingly, the model validation step 232 may also back-propagate error for the improvement of additional neural networks—one for each of the aforementioned factors. This may be done in step 236 such that the missing values are provided into the post-transformation data set going into processing step 222, and/or step 238 such that the missing data values are provided as primitive raw data 216 before the transformation processing in step 216.

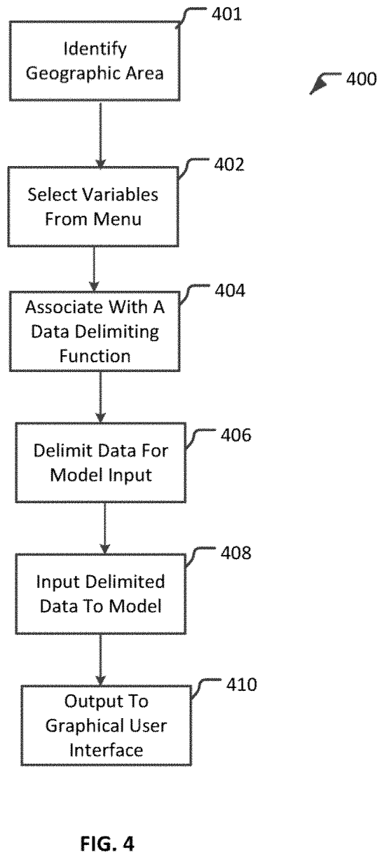

FIG. 4 shows program logic 400 for use of a graphical user interface (GUI). A user is able to identify 401 a geographic area. This may be done for example, by clicking on an image of a parcel, or by dragging a pointer around larger units of land. The user is next asked to select variables from a list of variables. The variables may include, for example, the subfactors discussed above, as well as other variables in association with the raw or primitive data. The selected variables are then associated 404 with a data delimiting function. The data delimiting function may be, for example, to use input data corresponding to data in the bottom quartile of a particular subfactor. Another way of delimiting data is to use a function that progresses the data over time. For example, if a source of water, such as ground water or ditch water, is declining by 10% per year, the input data may be reduced by 10% on the basis of a mathematical relationship representing the annual progression. Alternatively, the model input data may be delimited by using data averages for climactic events, such as ‘La Niña’ or ‘El Niño.’ Thus, the GUI provides a user with control over input data to assess worst-case or best-case concerns.

The system performs necessary calculations to delimit 406 the input data as requested. The delimited data is input 408 to the model, which calculates output on the basis of the delimited data set. The output is sent 410 to the graphical user interface for presentation to the user.

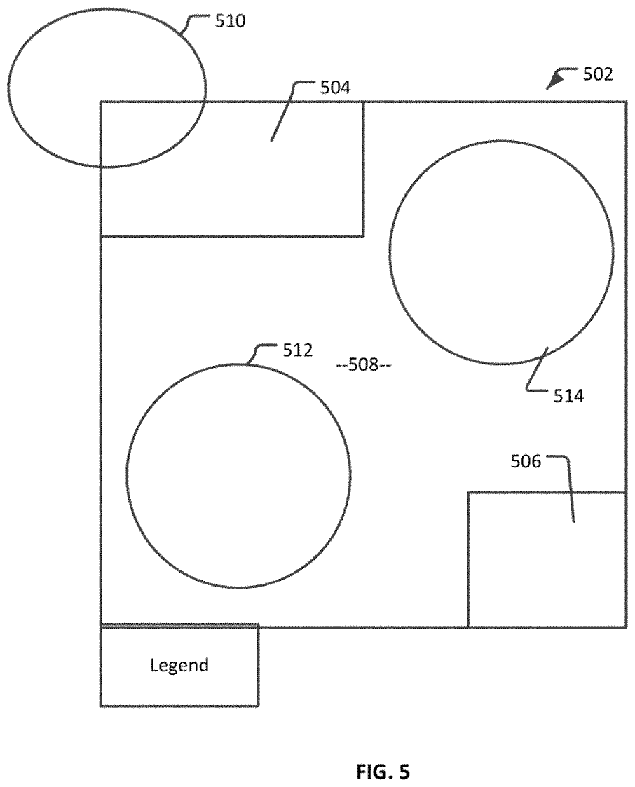

FIG. 5 shows a GUI according to one embodiment of this output. A section of land 502 includes parcels 504, 506, 508 under different ownership. The parcels 504-508 are differently situated in terms of water risk management. The parcel 504 is proximate a reservoir 510 that has a seasonal supply of water 510. The parcel 506 relies on rainwater. The parcel 510 has a well supplying center pivot systems 512, 514 with a steady and predictable supply of water. A model prepared according to FIGS. 2 and 3 may be used to provide output that is stratified to produce a numeric risk score which is associated with color by ranges. Thus, a visual presentation of the section 502 communicates the respective level of risk in parcels 504-508. Where one or more of the water sources affecting the respective parcels may vary with time, the water risk score may be animated as a time progression of this score.

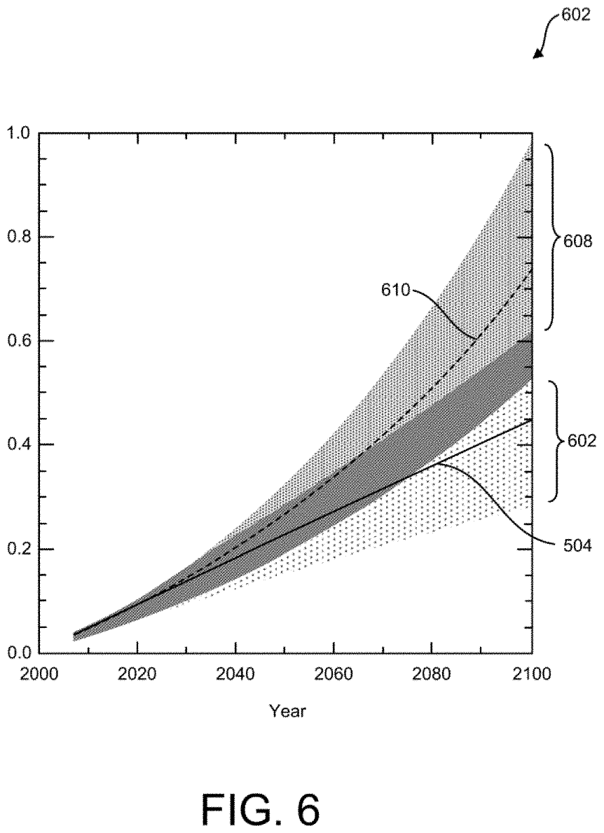

FIG. 6 shows another way of looking at time-progression of water risk in the form of chart 600. A first output set 602 is calculated according to a first set of delimited data. This first output data set has a range of uncertainty bounding a statistical mean that may be calculated for any type of statistical distribution, such as a normal, binomial, or triangular distribution. A second output set 608 is calculated according to a second set of delimited data. This second output data set has a range of uncertainty bounding a statistical mean that may be calculated for any type of statistical distribution, such as a normal, binomial, or triangular distribution. The first output data set 602 may be, for example, colored blue and the second output data set may be colored red, in order to facilitate visual and numerical comparison of the respective first and second output data sets 602, 608.

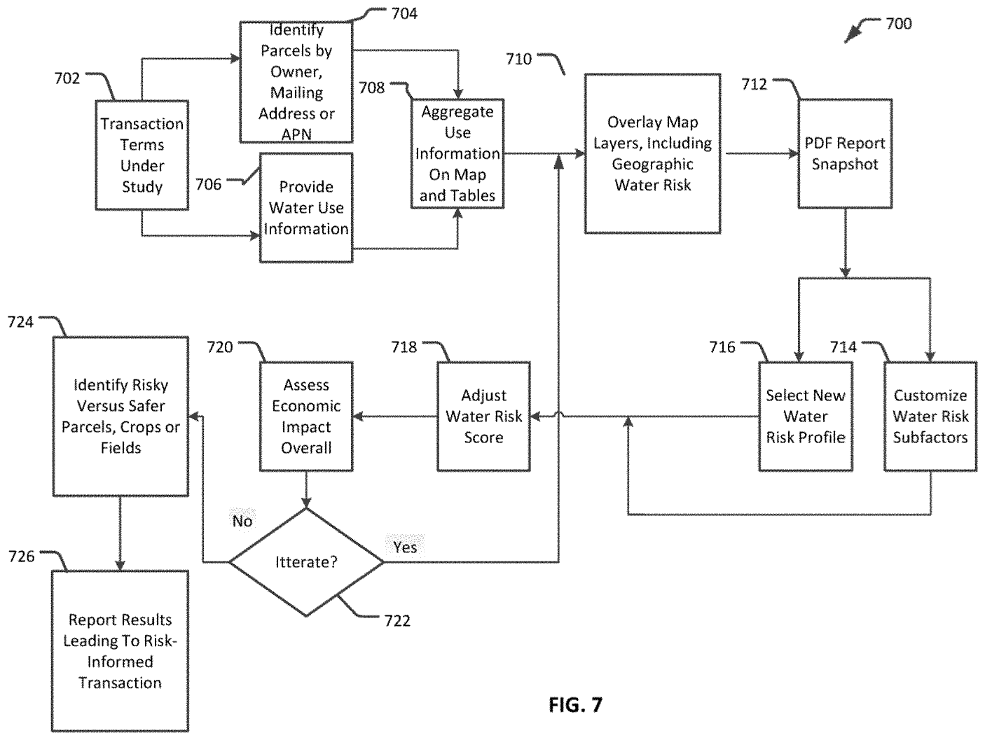

Generally speaking, the model that is created by the instrumentalities described above may be used in a number of practical applications. The various embodiments described below use statistical analysis to delimit the factors or subfactors and may, for example, ascertain an average or modal value from the delimited field that is used as input for the model. Thus, based upon a time-series or other analysis, a subfactor may be delimited by a 95% confidence level or a 5% confidence level that a certain amount of available water will be present in any given year. By way of example, FIG. 7 shows a process 700 according to one embodiment that may be implemented using program logic to inform a transaction in context of water risk. Step 702 entail entry of transaction terms that are under study. These terms may be, for example, those of an insurance policy that pays out if there is insufficient water to grow crops or to conduct a recreational enterprise, such as boating. Alternatively, the term may entail a loan for the purchase of property that will be used to grow crops. Step 704 entails identifying one or more parcels that will be subject to terms of the transaction. Step 706 entails providing water use information for each of the parcels, such as volumetric estimates of requirements for certain crops that will be grown on the parcels, minimum stream flows, or water to meet recreational requirements. In step 708, these uses are aggregated and associated with the parcels for reporting on a computer display as a map and in tables. The map may be overlain 710 in various layers includ8ng ownership, geographic information, use requirements, and baseline water risk. The map images may be reported 712, for example, in a PDF file.

Step 714 permits a user to select water risk subfactors, for example, by reporting with delimited ranges from among the subfactors discussed above. Additionally, step 716 permits the user to select reporting options that define a new water risk profile. For example, on or more of the subfactors may be delimited at a particular confidence level from among the subfactor dataset, such as a delimited dataset that contains a confidence level where the dataset is then represented at a 5%, 10%, 20%, 30%, 40%, 50%, 60%, 70%, 80%, 90% or 95% level of confidence that a the subfactor will meet a use requirement over time. These values are input to the model described above to adjust 718 the water risk score. An economic impact engine contains an economic model of the uses detailed in step 706 and may be used to assess 720 the overall economic impact of the delimited data set. This assessment may be iterated 722 any number of times to produce a report that identifies 724 risky versus safer parcels, crops or fields. These results may be reported 726 to provide an economic assessment of water risk.

### HYPOTHETICAL EXAMPLES

The following examples set forth specific applications and system modifications and additions for risk scores that may be produced according to the instrumentalities described above.

### Example 1—an Aid to a Lender Who Must Consider the Risk that a Shortage of Water May Cause an Agricultural Loan to Fail or that Such a Loan Might Need to be Refinanced

The system accepts either the borrowers name to see a list of all properties associated with the borrower, or the relevant Assessor's Parcel Number connected to the borrower's loan. The property or properties identified in this manner results in a GUI that shows the properties highlighted on a map interface, as well as in a list formed along a margin of the computer screen. The map allows the user to toggle specific data layers on and off the map, including a water risk layer. Each property may be selected to add to a report which, when a report tab is selected, allows review of all properties selected for the report. The user will then select whether he or she wants a baseline water risk calculation expressed as a score, or if the user would like to customize or load a custom profile prior to generating a report. The user may also select the economic impact analysis to better understand what the water risk means for the economic risk to one or more parcels of land. The system will generate a report that includes a risk score for each parcel and calculate the total water risk for the selected properties averaged by acreage. The system provides an overall risk and alerts the user to which properties, if multiple properties in the report, are the most and least risky. An economic impact report may be provided to accompany the water risk analysis based on the current crops on the reported parcels.

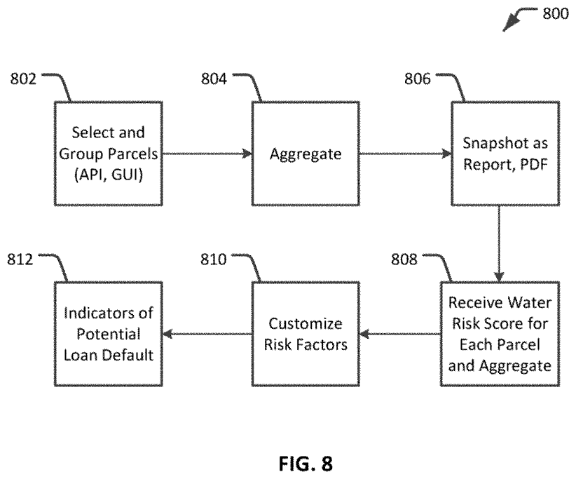

FIG. 8 shows a process 800 that may be implemented according to one embodiment using program logic such that the water risk analysis system functions as an aid to lender in evaluating the terms of an agricultural loan on the basis that a shortage of water may cause the loan to fail. An application program interface (API) or GUI assists the user with a geographic layout that assists the selection 802 and grouping of parcels that will be subject to the loan. The system then aggregates 804 the data for the group of parcels by determining such factors as how much water is available from different sources, how much water is required for crops that are envisaged as being grown, timing of water availability, and other subfactors discussed above. The system reports 806 the data in layers as screen snapshots \and/or tabularly in PDF or text format. The system calculates a water risk score for each parcel according to one or more intended uses for that parcel. The scores are aggregated 808, for example, by weight-averaging according to parcel risk score and acreage. Risk factors for each parcel may then be customized 810 for each parcel. Customization involves assessing which subfactors dominate the water risk scores. This may be done, for example, by using an iterative process to delimit the subfactors according to a percentile ranking of historical data, averaging the delimited data arrays, and running the average or delimited data through the water risk score model described above. The dominant subfactors are then characterized 812 as indicators of potential loan default

### Example 2: Water Management Planning by a Municipality or a State in Assessing a Need to Lock Up Sources of Water Supply that Will be Consumed by Contemplated Population Growth

The system is configured to facilitate a governing entity that runs projections on existing population growth projections that could integrate within the system analytics system through an application program interface (API). The governing entity would access a GUI that allows for setting the analysis for risk at a baseline or custom setting. The output of the integrated report is a time-series projection of both the population and the water risk calculation in monthly or yearly increments. Additionally, economic impacts of on crop commodities and water costs are generated. The governing entity will download the output in a variety of formats that suited their needs. A graphical report option allows a projection graph and necessary geographic information system files representing the time-series data.

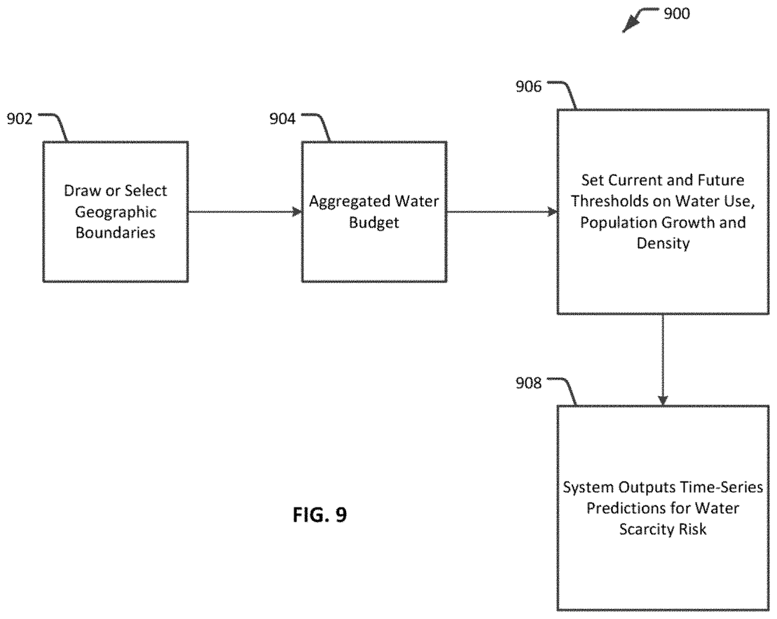

FIG. 9 shows a process 900 that may be implemented according to one embodiment using program logic such that the water risk analysis system functions as an aid to water management planning by a municipality or a State in acquiring sources of water supply that will be consumed by contemplated population growth. An API, GUI or table of parcels may be used to draw or select 902 geographic boundaries for the study. A system of expert rules or a correlation based on historical uses for the parcels within the geographic boundary may be utilized to provide an aggregated water budget 904 for the aggregated parcels. The system permits the user to set 906 current an future thresholds on water use according to population growth and population density estimates. This may be done at the parcel level, as well as the level of geographic area aggregate demand. The model, which is produced as described above, provides output 908 representing time-series predictions that include water scarcity risk assessments over time.

### Example 3: A Farmer Who is Determining What Crop to Grow

A farmer inputs the Assessor's Parcel Number of the parcel they are researching. The system output is a highlighted outline of the parcel matching the parcel number, as well as a written list on the margin of the computer screen. The farmer selects an advanced system analytics button that results in a GUI permitting the user to select options for various crops and proceed to generate a water risk report for each selection The options allow the farmer to narrow the water risk assessment to a specific type of crop or multiple crops for comparison. The options allow the farmer to set the increments of projection to seasons or years. The options allow the farmer to select whether he or she wants economic projection included in the output. The farmer would then generates a report which generates a PDF with a map of the parcel, risk of planting a crop based on the water risk to that crop, and the economic projections by crop for that parcel.

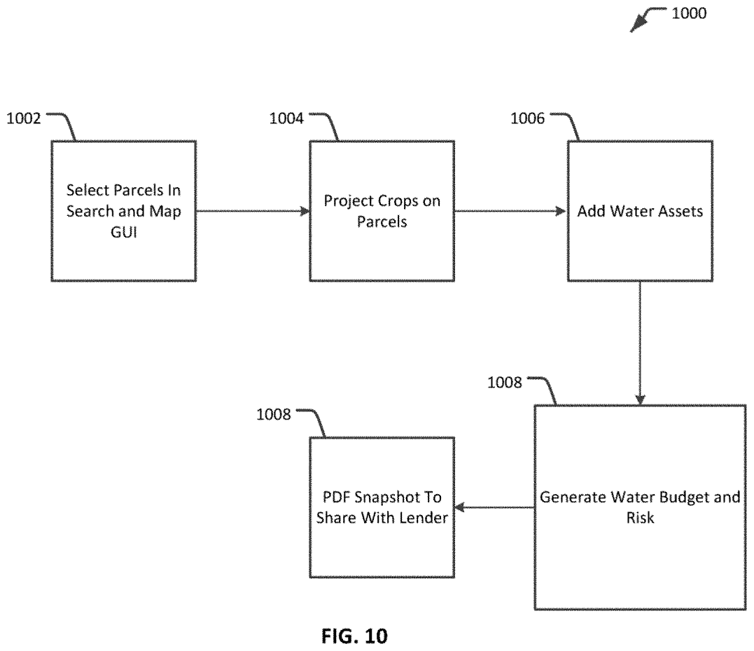

FIG. 10 shows a process 1000 that may be implemented according to one embodiment using program logic such that the water risk analysis system functions as an aid to a farmer who is determining what crop to grow. A search function or GUI permits a user to select 1002 parcels. The user may project 1004 proposed crops for growth on the parcels where each crop mis associated with an estimate of the amount of water that is required to grow the crop. Available water assets are added 1006 to generate a budget 1008 of available water, as well as a risk assessment whether the amount of available water will meet requirements for growing the proposed crops provided in step 1004. A report is made 1008 that may be shared with a lender as a screen snapshot or table characterizing the risk assessment.

### Example 4: An Aid to a Regulatory Agency that is Planning to Provide Minimum Required Stream Flows

An employee of the regulatory agency clicks on an enterprise planning scenario module (EPS). The agency employee then defines their area of interest by country, state, county, water district, groundwater basin, or assessor's parcel number. The EPS provides a sandbox like environment to input and modify existing data related to, but not limited to:
i. Snowpack
ii. Precipitation
iii. Surface Water Flows
iv. Groundwater Level
v. Crops
vi. Soil Type
vii. Cost of Water
viii. Cost of Electricity
ix. Major Water Project Allocation Percentages
x. Reduction in water deliveries

The agency employee is then able to customize each EPS variable, select inclusion of the baseline non-customized scenario, and select to include dry year or wet year scenarios. The system output results in an overview of any customizations made to the EPS and a graph representing the custom scenario, the baseline scenario, the wet year scenario, and the dry year scenario. The scenarios may be viewed by month, season, or year. The employee has the option to print a report which includes the EPS output overview, and relevant background information for the area of interest selected by the agency user. The report may then be attached to a policy or other decision analysis when determining whether to release water at a certain time of year, withhold water to decrease flows, and the impact on the agricultural economy based on the changes in flow.

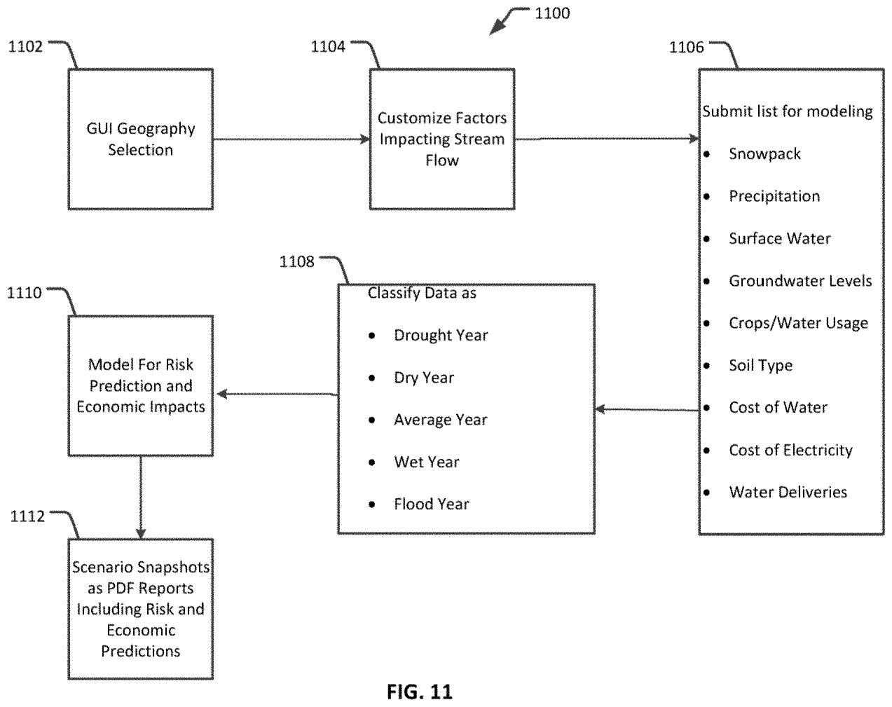

FIG. 11 shows a process 1100 that may be implemented according to one embodiment using program logic such that the water risk analysis system as an aid to a regulatory agency that is planning to provide minimum required stream flows. A user accesses a GUI to select 1102 a geographic area. The user may select a customized list of subfactors 1104 for modeling consideration from, and these are submitted for modeling 1106. The system delimits these subfactors according to predetermined confidence levels, such as by quartile or pentile over time, such that the average or modal values of the remaining dataset may be classified, for example, as representing a drought year, a dry year, an average year, a wet year or a flood year. Alternatively, the data may simply be classified by quartile, pentile, etc. The delimited data is submitted to modeling 1110 to predict risk and associated economic impacts. The modeling outcomes may be reported 1112 as scenario snapshots including risk and economic predictions.

### Example 5: Prior Apportionment Using a Synthetic Data Set According to California Regulation

In California, the state and federal government allocate water from the State Water Project and Central Valley Water Project. Water Districts are limited at times through curtailment that may impact original supply allocations. Crop Water Demand numbers from a synthetic data set are used as a proxy to determine how much water a property would use without engaging in an accounting of what was used. Water efficiency measures available to the grower are not taken into consideration. A water budget is then constructed from the water supply and water demand numbers calculated to the acre-foot of water per acre of land. When supply or demand data is insufficient, an intelligent algorithm interprets other data sources including, but not limited to:
i. Contracted maximum water amounts and allocation percentages
ii. Time-Series Surface water flow data if applicable
iii. Time-Series Crop Data for the parcel
iv. Time-Series Precipitation data
v. Available Time-Series Water Delivery data for water district where a parcel is located.

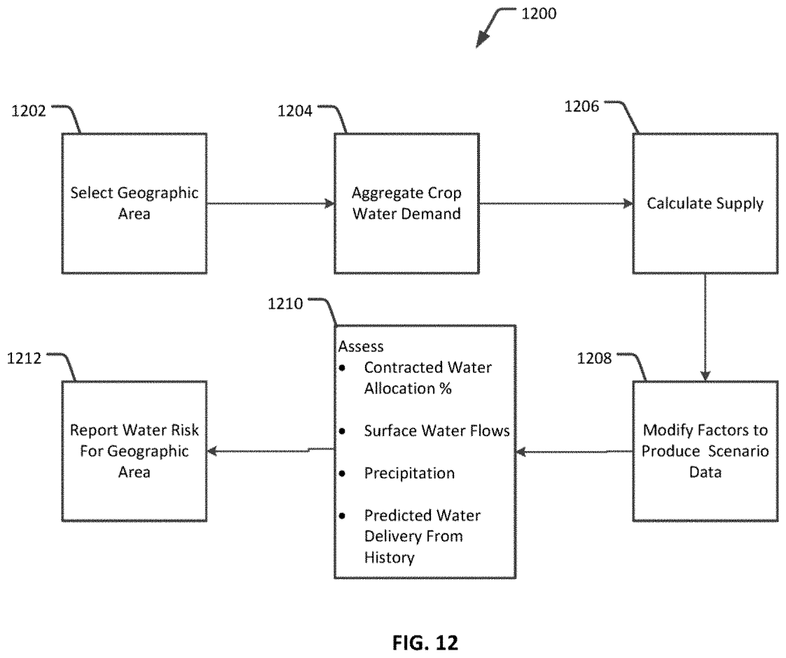

FIG. 12 shows a process 1200 according to one embodiment that may be implemented using program logic such that the water risk analysis system functions as an aid to conduct prior apportionment analysis using a synthetic data set. A user selects 1202 a geographic area by use of an API, GUI, table or reporting system. Water demand for the crops grown in the area is aggregated 1204. The available water supply is calculated 1206. The user accesses a list of subfactors that are modified 1208 by delimitation to produce scenario data. The system uses the scenario data to use the model created as described above to independently assess 1210 the water that is available to meet requirements for crop water from various sources, such as contracted water allocations, surface water flows, precipitation, and historical water deliveries under the scenario assumptions. This assessment is then allocated to the parcel level on the basis of prior apportionment or the historical use of water on the parcel The system can then report 1212 the water risk for each parcel in the geographic area.

### Example 6: Insurance Policy that Considers Risk that of a Shortage of Water May Cause an Insurance Policy to Distribute Insurance Proceeds

The system accepts either the insured name to see a list of all properties associated with the insurance policy, the relevant Assessor's Parcel Number connected to the insurance policy, or the crops being grown associated with the insurance policy. The property or properties identified in this manner results in a GUI that shows the properties or crops highlighted on a map interface, as well as in a list formed along a margin of the computer screen. The map allows the user to toggle specific data layers on and off the map, including a water risk layer. Each property may be selected to add to a report which when a report tab is selected allows review of all properties selected for a report. The user will then select whether he or she wants a baseline water risk calculation or if the user would like to customize or load a custom profile prior to generating a report. The user may also select the economic impact analysis to better understand what the water risk means for the economic risk to one or more parcels of land. The system will generate a report that includes a risk score for each parcel and calculate the total water risk for the selected properties providing an overall risk and alerting to which properties, if multiple properties in the report, are the most and least risky. An economic impact report may be provided to accompany the water risk analysis based on the current crops on the reported parcels.

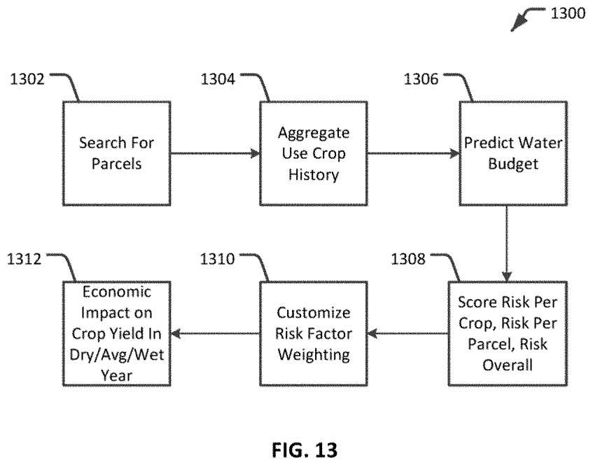

FIG. 13 shows a first embodiment of a process 1300 that may be implemented using program logic such that the water risk analysis system functions as an aid to evaluating an insurance policy which considers risk that a shortage of water may cause the insurance policy to distribute insurance proceeds. policy by considering risk that of a shortage of water may cause the insurance policy to distribute insurance proceeds to a farmer. A search 1302 identifies parcels that would be subject to the insurance policy. The historical use for each parcel is aggregated 1304 for each type of crop grown on the parcels. A budget of water requirements is predicted 1306, and the system assesses risk by scoring 1308 the risk per crop, risk per parcel, and overall risk for all parcels under the proposed policy. A reporting feature permits the user to select and adjust 1310 for customized wieghting factors for each subfactor that is utilized in a neural network model as described above. Thus, for example, if the parcel is certain to receive a fixed amount of ditch water or groundwater each year, these the weights for these factors may be held constant and the other factors may be adjusted by user choice or by an approach such as by Monte Carlo simulation that chooses numbers from a defined range of weighting factors.

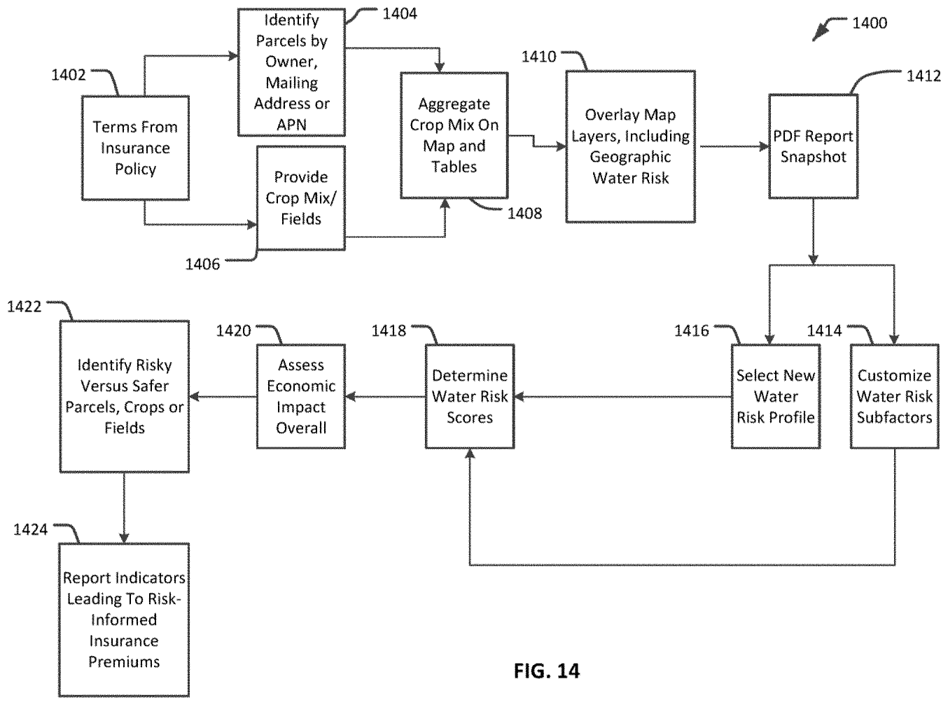

FIG. 14 shows a second embodiment of a process 1400 that may be implemented using program logic such that the water risk analysis system functions as an aid to evaluating an insurance policy which considers risk that a shortage of water may cause the insurance policy to distribute insurance proceeds. policy by considering risk that of a shortage of water may cause the insurance policy to distribute insurance proceeds to a farmer. Terms 1402 from an insurance policy 1402 are used to identify parcels 1404 under the policy terms. This identification may be performed using the owner name, mailing address, or parcel number associated with the policy. The insurance policy also identifies the mix of crops 1406 that will be grown on each parcel.

The system calculates layers that may be overlain on a map including, for example, water demand per crop and parcel, a budget of available water, and a score of water risk that the demand will exceed the budget. Images of the map including selected layers may be reported 1412 as a screen snapshot. The analysis may then proceed to customize 1414 the water risk subfactors by statistical delimitation as discussed above, or to access 1416 predefined reports reflecting different water risk profiles, for example, as wet year, dry year, or average year. Water risk scores may then be determined 1418 with the associated waster budget curtailing available water as an economic model is used to assess 1420 the economic impact of the delimited subfactors as determined in steps 1414, 1426. These scores are allocated to individual parcels to indicate, for example, by a colorized scale or contour intervals, which parcels over the geographic range of the policy are at risk of having the policy pay out a claim. The system issues a report 1424 that may be used to inform an insurer and the insured of water risk.

Those of ordinary skill in the art will understand that the foregoing discussion teaches by way of example and not be limitation. Accordingly, what is shown and described may be subjected to insubstantial change without departing from the scope and spirit of invention. The inventors hereby state their intention to rely upon the Doctrine of Equivalents, if needed, in protecting their full rights in what is claimed.

We claim:

1. A water risk analysis system comprising:
a processor;
a memory;
a risk mitigation module stored in the memory with program instructions that are executable by the processor and configured for:
running an artificially intelligent algorithm that has been trained as a model for water risk analysis to assess a score indicating relative risk whether a geographic area of land has access to a sufficient water supply for an intended use under a system of supply regulation,
wherein the artificially intelligent algorithm results from a training data set including variables affecting water supply, water supply reliability, cost of water, and water quality associated with a geographic area, and;
inputs to the artificially intelligent algorithm include variables affecting water supply, water supply reliability, cost of water, water quality, and identification of the geographic area;
obtaining the score from the artificially intelligent algorithm; and
presenting the score to a user of the water risk analysis system through use of a graphical user interface (GUI).

2. The water risk analysis system of claim 1, further comprising a synthetic data set of estimated values for one or more of the variables where actual values are unavailable in raw data used to train the model, and
the synthetic data set is used to train the artificially intelligent algorithm in producing the model.

3. The water risk analysis system of claim 2, wherein the artificially intelligent algorithm is a first neural network.

4. The water risk analysis system of claim 3, wherein further comprising program instructions for a second neural network adapted for creating the synthetic data set.

5. The water risk analysis system of claim 1, wherein the artificially intelligent algorithm is a neural network.

6. The water risk analysis system of claim 1, further comprising program instructions for submitting the score to downstream processing.

7. The water risk analysis system of claim 6, wherein the instructions for downstream processing apply the score as an aid to a lender who must consider the risk that a shortage of water may cause an agricultural loan to fail or that such a loan might need to be refinanced.

8. The water risk analysis system of claim 6, wherein the instructions for downstream processing apply the score as an aid to governmental planning in assessing a need to lock up sources of water supply that will be consumed by contemplated population growth.

9. The water risk analysis system of claim 6, wherein the instructions for downstream processing apply the score as an aid to farm crop planning.

10. The water risk analysis system of claim 6, wherein the instructions for downstream processing apply the score as an aid to regulatory planning to meet minimum required stream flows.

11. The water risk analysis system of claim 1, wherein the system of supply regulation is a prior appropriation system.

12. The water risk analysis system of claim 1, wherein the system of supply regulation is a riparian system.

13. The water risk analysis system of claim 1, wherein the model encompasses multiple water sources selected from the group consisting of ditch water, river water, ground water, and well water.

14. The water risk analysis system of claim 1, wherein the instructions for presenting the score include associating the score with a color and the geographic area.

15. The water risk analysis system of claim 14, wherein the instructions for presenting the score include those for presentation of score values that change over time.

16. The water risk analysis system of claim 14, further comprising instructions for reporting to delimit the input data set according to user defined parameters.

17. A computer program product for water risk analysis comprising a non-transitory computer-readable storage medium having computer-executable instructions for:
with program instructions that are executable by the processor and configured for:
running an artificially intelligent algorithm that has been trained as a model for water risk analysis to assess a score indicating relative risk whether a geographic area of land has access to a sufficient water supply for an intended use under a system of supply regulation,
wherein the artificially intelligent algorithm results from a training data set including variables affecting water supply, water supply reliability, cost of water, and water quality associated with a geographic area, and;
inputs to the artificially intelligent algorithm include variables affecting water supply, water supply reliability, cost of water, water quality, and identification of the geographic area;
obtaining the score from the artificially intelligent algorithm; and
presenting the score to a user of the water risk analysis system through use of a graphical user interface (GUI).

18. A method for water risk analysis, comprising:
training an electronically based artificially intelligent algorithm as a model for water risk analysis to assess a score indicating relative risk whether a geographic area of land has access to a sufficient water supply for an intended use under a system of supply regulation,
wherein the artificially intelligent algorithm results from a training data set including variables affecting water supply, water supply reliability, cost of water, and water quality associated with a geographic area, and;
inputs to the artificially intelligent algorithm include variables affecting water supply, water supply reliability, cost of water, water quality, and identification of the geographic area;
running the model to obtain the score from the artificially intelligent algorithm; and
presenting the score to a user of the water risk analysis system through use of a graphical user interface (GUI).
